(19) United States
(12) Patent Application Publication
(10) Pub. No.: US 2011/0181716 A1
(43) Pub. Date: Jul. 28, 2011

(54) VIDEO SURVEILLANCE ENHANCEMENT FACILITATING REAL-TIME PROACTIVE DECISION MAKING

(75) Inventors: Daniel Scott McLeod, Camarillo, CA (US); Daniel Monte Walton, Camarillo, CA (US)

(73) Assignee: Crime Point, Incorporated, Camarillo, CA (US)

(21) Appl. No.: 12/692,585

(22) Filed: Jan. 22, 2010

(51) Int. Cl. H04N 7/18

(52) U.S. Cl. 348/143; 348/E07.085

(57) ABSTRACT

A proactive surveillance enhancement system and method that gives an operator an overview of a surveillance area while simultaneously allowing the operator to focus on specific details in the surveillance area. The operator is used to make decisions about what activity, object, and persons in the surveillance area warrant further investigation. Embodiments of the system and method include one or more overview cameras, which provide an overview of the surveillance area, and a pan-tilt-zoom (PTZ) camera, which provides detailed video as directed by the operator. Embodiments of the system and method display to the operator an overview video feed (as captured by the overview camera) and the inspection video feed (as captured by the PTZ camera) in a graphical user interface. The operator is able to control the PTZ camera from both the overview video feed and the inspection video feed.

### BACKGROUND

Typical video surveillance systems used by law enforcement serve to document criminal or suspicious activity for review at a later time. Some time after the video data is obtained the data may be reviewed by law enforcement officers conducting the investigation. Thus, traditional law enforcement video surveillance documents criminal activity that has already occurred. In this sense, traditional law enforcement surveillance is reactive, in the sense that law enforcement can only react to some criminal activity that has occurred in the past as opposed to criminal activity that is currently occurring.

Because most law enforcement video surveillance systems are designed for reactive investigation, these current video surveillance systems include varying degrees of automation. This automation is designed to minimize the time required for a law enforcement officer to interact with these systems. One category of current video surveillance system uses a single pan-tilt-zoom (PTZ) camera that responds and zooms to motion. Using only a single PTZ camera, however, can completely miss the original field of view. To overcome this problem, another category of current video surveillance system uses two cameras: a wide-angle (or overview) camera and a PTZ camera. The overview camera typically captures an entire overview of a particular scene, while the PTZ camera is used to provide greater detail of a desired area, person, or object within the field-of-view of the overview camera.

Regardless of the number of cameras used, many of the current automated video surveillance systems require an initialization by a user prior to system deployment. During this initialization stage the user will be presented with an overview image from the overview camera. The user then will define one or more regions of interest within the overview image. A region of interest is an area in the overview image that the user determines may be of interest and need further detail. For example, the user may determine that the door and windows of a house under surveillance may be regions of interest. Typically, the user will use a user interface to draw a box (or other type of boundary) around these regions of interest. After this initialization is completed by the user and the regions of interest have been pre-defined, then the system is left to run automatically on its own.

In order to further automate the video surveillance, many of the current video surveillance systems also use motion detection algorithms to detect any activity within the pre-defined regions of interest. This means that during the initialization stage the user determined that if any activity (which is defined by these systems as motion) occurs in the pre-defined regions of interest, then a closer look should be taken at that area. Typically, this closer look is in the form of a PTZ camera that is zoomed to the pre-defined region of interest.

One problem, however, with systems that require a region of interest to be defined during initialization is that a new region of interest may pop up after initialization. An important new region of interest may appear in the camera's field-of-view that the user did not know about (or may have missed) during the initialization stage. For example, suppose that during an active law enforcement investigation there is a house with a driveway that is under surveillance by law enforcement. Perhaps during the initialization stage an officer identified as regions of interest the entrance to the driveway and a door and a window on the house. This was done by the officer with him realizing that there were cars parked on the street in front of the house that were also related to the criminal activity. The criminal activity related to the cars will be missed based on the error during the initialization stage.

Another problem is that activity in the region of interest that is extraneous to the investigation cannot be filtered out. Using the above example, if the door was initialized as a region of interest some current systems will react and zoom in on the door even if there is no criminal activity. In other words, most current systems will not differentiate between a suspect and a girl scout coming out of the door. In either case, the system will zoom in on the region of interest merely because it was predefined as a region of interest.

Another problem with motion detection-based systems is that both too much motion and too little motion can cause important information to be missed. When there is little or no motion current systems will not zoom in on a predefined region of interest and can miss important information. For example, suppose there is a car parked in front of a house and there are multiple predefined regions of interest. Assume further that the parked car was defined in the initialization stage as one of the multiple regions of interest. For motion-based video surveillance systems, if there is no motion within the parked car then the system will not cause the PTZ camera to zoom in on the region of interest containing the parked car. This becomes a problem if due to criminal activity occurring after initialization the parked car becomes important to the investigation. The system will not have zoomed in to the region of interest because there was no motion in the car, and thus the license number of the car may be lost.

When there is too much motion current motion-based systems may become confused and mislead by the motion. This occurs most often when there is activity in multiple predefined regions of interest. For example, an agency may be conducting surveillance on an arena that has multiple entrance points where people are walking through entrances to enter the arena. If each door of the arena is a region of interest, the system will want to zoom in on each door simultaneously. In order to avoid this, these systems prioritize conflicting regions of interest based on time. During the initialization stage the user programs the system with some dwell time and conflict order in case there is simultaneous activity in multiple predefined regions of interest. When this occurs, current systems will go to the first region of interest in the conflict order for the duration of a certain dwell time. Once the dwell time has expired, the system then will go to the next region of interest based on the order for the duration of the dwell time, and so forth. However, there may be suspicious activity or a suspicious person that is missed because it occurs at an arena door that is not currently being shown.

Yet another problem with some current motion-based systems is that they lack specificity. The zoom based on the motion of an object may not be enough. This is because the system zooms in to the size of the object. For example, if a car is going by the camera will zoom in to the size of the car. If a person runs across the street, the camera will zoom to the size of the person. However, it may be desirable to know the license plate of the car or zoom in on the hand of the person. These current systems have no way of knowing whether to zoom in on the entire car or the license plate, or the entire person or the hand of the person.

### SUMMARY

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

Embodiments of the proactive surveillance enhancement system and method allow an operator to maintain an overview of a surveillance area while simultaneously focusing on specific details in the surveillance area. Embodiments of the system and method use the operator to make decisions about what activity, object, and persons in the surveillance area warrant further investigation. This allows proactive decisions to be made in real time about the surveillance.

As opposed to reactive video surveillance, embodiments of the proactive surveillance enhancement system and method are designed for real-time enhancement of gathering information. This facilitates real-time decision making. For example, in a live investigation, there may be a need to make decisions about whether a car needs to be stopped, whether a person has a gun, whether a person has contraband, or whether the person is involved in illegal activity at the present time. Proactive video surveillance means that specific information can be taken at the present time so that the operator can direct others to take specific action or take the action himself.

Embodiments of the proactive surveillance enhancement system and method include one or more overview cameras, which provide an overview of the surveillance area, and a pan-tilt-zoom (PTZ) camera, which provides detailed video as directed by the operator. Having two different types of cameras allows the operator (such as law enforcement personnel) to observe a general overview of a scene while simultaneously allowing the operator to zoom in on an region of interest by drawing a boundary (or box) in a video feed. This may be the overview video feed, which displays the video captured by the overview camera, or the inspection video feed, which displays the video captured by the PTZ camera.

It should be noted that digital zoom (instead of optical zoom) may possibly be adapted to maintain an overview. However, this is computationally intensive and results in a loss of quality at some point of enhancement. Moreover, using at least two cameras allows both the overview video feed and the inspection video feed to be recorded. Digital zoom can only record one view or another, but not both simultaneously. While it is possible with megapixel cameras for a single view to be recorded and the recording to be enhanced or “zoomed in” on, this cannot be performed in real time. In addition, using a fixed overview camera and a PTZ camera in some cases is much less expensive than using two PTZ cameras. The fixed camera does not need to be a PTZ camera, thereby saving costs.

Embodiments of the system and method allow on-the-fly defining of a region of interest by the operator without the need for predefined regions of interest. Moreover, motion with a region of interest has no effect on the PTZ camera or the system at all. Thus, there is no need for dwell times or conflict rules. In existing systems, an initial region of interest may be defined around a window of a house. When an activity (such as motion) occurs in the window, the PTZ camera will zoom in on the window. However, this may not be sufficient detail necessary for the investigation. With the proactive surveillance enhancement system and method, the PTZ camera will go to the window, but if it is necessary to obtain further detail (such as a serial number) the PTZ camera can further zoom in within the initial region of interest when the operator defines a small region of interest within the initial region of interest. All this can be done in real time. In other words, instead of just going to the predefined region of interest whenever there is activity within the region, the proactive surveillance enhancement system and method can further enhance and redefine the initial region of interest to obtain further detail and specificity.

This gives embodiments of the system and method advantages over current surveillance systems that require initialization. Current systems tend to miss certain events during surveillance simply because the regions of interest are defined in the initialization stage. For example, suppose the surveillance area is a house and an original region of interest is a doorway, and there is a car on the street in front of the house. It is possible that after initialization and after the operator has left the surveillance system to run on its own that kids may be coming in and out of the doorway but a drug deal is occurring in the car parked in front of the house. Current systems would miss the activity in the parked car since the pre-defined region of interest was the doorway.

In addition, the embodiments of the system and method are different from current surveillance systems that merely use motion to zoom in a PTZ camera. The proactive surveillance enhancement system and method look for areas of genuine interest to the user as directed by the operator as opposed to merely looking for a disturbance in the pixels. The operator is an integral part of the system. In addition to enhancing information obtained by the system and method, this eliminates false movements and unwanted video capture and reduces potential liability and false alarms.

Embodiments of the proactive surveillance enhancement system and method allow constant and instant modification of a region of interest as determined by the operator. Instead of zooming in when motion in detected, the system and method wait for direction from the operator as to which area to provide further detail. For example, when zoomed in on the parking space of a car, the defined area may not have enough zoom to read the car's license plate. The system and method enable the operator to identify not only the parking space where the car is parked, but also to further define the region of interest to the license plate. All this occurs while the operator is able to maintain overall situational awareness of the surveillance area.

Embodiments of the proactive surveillance enhancement system and method display to the operator the overview video feed and the inspection video feed in a graphical user interface. The two video feeds are displayed simultaneously in close proximity to each other. Moreover, the operator is able to control the PTZ camera from both the overview video feed and the inspection video feed. While there are some video surveillance systems that allow viewing of two cameras in a single graphical user interface, embodiments of the proactive surveillance enhancement system and method also have the feature of be able to control the PTZ camera through the overview video feed or the inspection video feed. In addition, once a region of interest is defined by the operator in either the overview video feed or the inspection video feed, the PTZ camera moves immediately to that desired location to display the region of interest.

Embodiments of the proactive surveillance enhancement system and method avoid the problem missing important information because of too little motion by using an operator. For example, even if there is not motion in a car if the operator determines that it is important to obtain the car's license plate number the operator can do this by defining a second region of interest within the first region of interest to zoom in on the license plate number.

Embodiments of the proactive surveillance enhancement system and method avoid the problem of too much motion by having the operator prioritize by what the operator thinks is important. In other words, the operator makes decisions in real-time. Embodiments of the system and method also have on-the-fly real-time region of interest conflict prioritizing. But because the operator is making the decision of instantaneous regions of interest, he is able to prioritize by importance. Using the example above, the agency may be conducting surveillance on an arena that has multiple entrance points where people are walking through entrances to enter the arena. The agency may want their operator to have an entire overview of what going on and be able to select which arena entrance is most important at any given moment in time. For example, if, as people are streaming through the entrances, the operator sees suspicious activity or a suspicious person, the operator may zoom in on the suspicious activity but retain situational awareness.

It should be noted that alternative embodiments are possible, and that steps and elements discussed herein may be changed, added, or eliminated, depending on the particular embodiment. These alternative embodiments include alternative steps and alternative elements that may be used, and structural changes that may be made, without departing from the scope of the invention.

### DRAWINGS DESCRIPTION

Referring now to the drawings in which like reference numbers represent corresponding parts throughout:

FIG. 1 is a block diagram illustrating a general overview of embodiments of the proactive surveillance enhancement system and method implemented on a computing device.

FIG. 2 is a flow diagram illustrating the general operation of embodiments of the proactive surveillance enhancement system shown in FIG. 1.

FIG. 3 is a flow diagram illustrating the operational details of a first embodiment of the proactive surveillance enhancement system shown in FIGS. 1 and 2.

FIG. 4 is a flow diagram illustrating the operational details of a second embodiment of the proactive surveillance enhancement system shown in FIGS. 1 and 2.

FIG. 5 is a flow diagram illustrating the operational details of a third embodiment of the proactive surveillance enhancement system shown in FIGS. 1 and 2.

FIG. 6 illustrates an example of a suitable computing system environment in which embodiments of the proactive surveillance enhancement system and method shown in FIGS. 1-5 may be implemented.

### DETAILED DESCRIPTION

In the following description of embodiments of the proactive surveillance enhancement system and method reference is made to the accompanying drawings, which form a part thereof, and in which is shown by way of illustration a specific example whereby embodiments of the proactive surveillance enhancement system and method may be practiced. It is to be understood that other embodiments may be utilized and structural changes may be made without departing from the scope of the claimed subject matter.

### I. System Overview

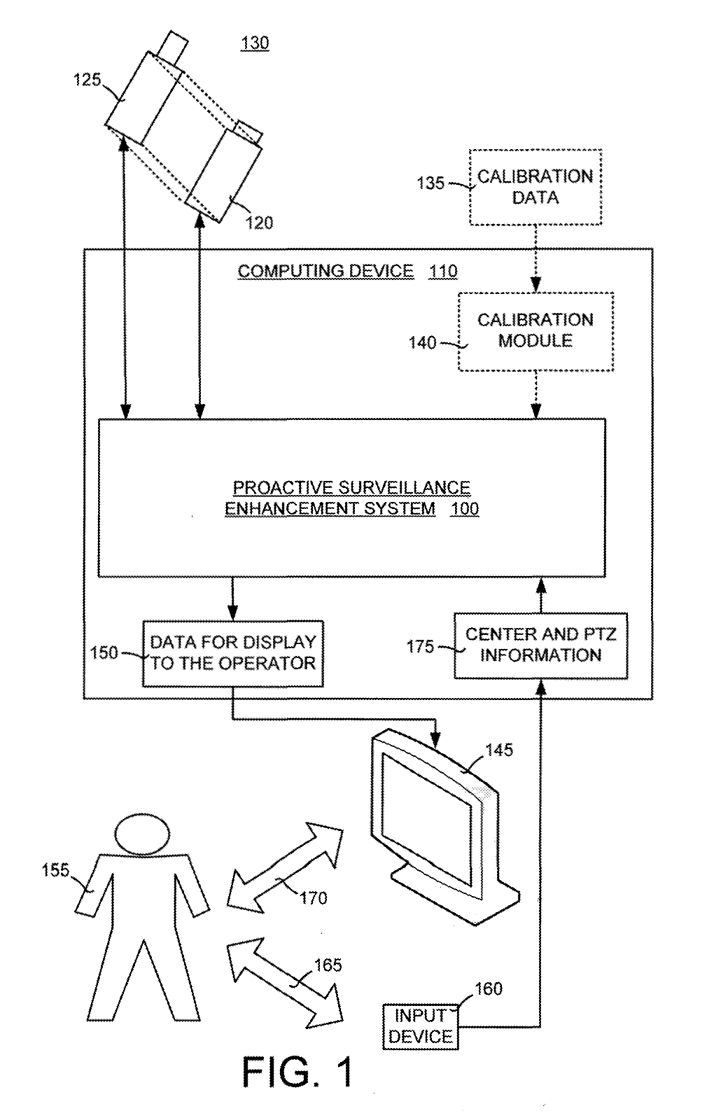

FIG. 1 is a block diagram illustrating a general overview of embodiments of the proactive surveillance enhancement system 100 and method implemented on a computing device 110. In general, embodiments of the proactive surveillance enhancement system 100 and method simultaneously display an overview and a detailed view of a surveillance area to an operator to allow the operator to zoom in on a specific region of interest within the surveillance area as determined by the operator while retaining a situational awareness of the entire surveillance area. This enables the operator to make real-time proactive decisions during the surveillance about activity occurring in the surveillance area. For example, if criminal activity is occurring in the surveillance area, the operator (who may be a law enforcement officer) can decide based on the information provided by the system 100 whether to continue to gather incriminating evidence or dispatch additional personnel to make an arrest.

More specifically, embodiments of the proactive surveillance enhancement system 100 shown in FIG. 1 include an overview camera 120 and a pan-tilt-zoom (PTZ) camera 125. It should be noted that while only a single overview camera 120 is shown in FIG. 1, the overview camera 120 may in fact be one or more overview cameras. Throughout this document the term “overview camera 120” will be used to mean one or more overview cameras 120. The overview camera 120 typically has a wide-angle lens and is trained on a surveillance area 130 and provides an overview of the surveillance area 130. In some embodiments the overview camera 120 is fixed. The PTZ camera 125 has a zoom lens that can zoom in on a specific area in the surveillance area 130. In addition, the PTZ camera 125 allows both pan and tilt enabling the PTZ camera 125 to be trained on any portion of the surveillance area 130.

Although in FIG. 1 only one overview camera 120 and one PTZ camera 125 are shown, it should be noted that other configurations are possible. In particular, in some embodiments the system 100 includes one or more overview cameras 120 and a single PTZ camera 125. Still other embodiments include a single overview camera 120 and multiple PTZ cameras 125. Other possible embodiments include multiple overview cameras 120 and multiple PTZ cameras 125.

In some embodiments the overview camera 120 and the PTZ camera 125 are in close proximity and may even be in physical contact with each other. In some embodiments, as shown FIG. 1 by the dashed lines, the single PTZ camera 125 is located on top of the single overview camera 120. In other embodiments, the two cameras 120, 125 are separated by many feet or yards. One difficulty that may arise with locating the overview camera 120 and the PTZ camera 125 away from each other is that objects close to the cameras 120, 125 usually cannot be seen. However, this usually is not a problem for surveillance work, where the cameras 120, 125 are far enough removed from a desired surveillance area that the cameras 120, 125 can see most or all of the desired surveillance area 130.

Embodiments of the proactive surveillance enhancement system 100 are calibrated upon initial deployment using calibration data 135 that is input to a calibration module 140. In some embodiments this calibration data 135 includes multi-point calibration data about the overview camera 120. Typically, this calibration data 135 is coordinates expressed in degrees offset from a defined center point. This calibration data 135 corrects for any deviation from center that the overview camera 120 may be positioned. For example, if the overview camera 120 is pointed away from center by 2 degrees, then this calibration data 135 is input to the calibration module 140 in the form of coordinates in degrees offset from the center of the overview camera 120. The calibration module 140 also receives input as to the viewing angle of the overview camera 120.

The calibration module 140 processes the calibration data 135 in order to make the PTZ camera 125 appear as though the overview camera 120 and PTZ camera 125 are co-located. This is true even though the fixed and PTZ cameras physically may be located far from each other. It should be noted that the calibration module 140 is run only when the overview camera 120 is initially positioned. As long as the overview camera 120 does not move then the calibration module 140 does not need to be run again. This fact is depicted in FIG. 1 by showing the calibration data 135 and the calibration module 140 outlined in dashed lines.

Embodiments of the proactive surveillance enhancement system 100 also include a display device 145 in communication with the computing device 110. Embodiments of the system 100 input video and other data from the overview camera 120 and the PTZ camera 125. As explained in detail below, embodiments of the system 100 process data from the cameras 120, 125 and output data 150 for display to an operator 155. This output data 150 is displayed on the display device 145 to the operator 155, typically in the form of a graphical user interface (not shown). The graphical user interface displays both video from the overview camera 120 and the PTZ camera 125 simultaneously to the operator 155. The operator 155, who is an integral part of the system 100, makes real-time proactive decisions based on the information provided to the operator 155 from the cameras 120, 125 through the graphical user interface.

Typically, the operator 155 is a trained professional (such as law-enforcement officer) that is capable of quickly making correct decisions and exercising good judgment. Embodiments of the system 100 allow the operator 155 to interact with the system 100 through an input device 160 in communication with the computing device 110. For example, this input device 160 may be a mouse or a touch pad. As explained in more detail below, the operator 155 monitors the surveillance area 130 using the cameras 120, 125 through the graphical user interface on the display device 145. Once the operator 155 sees some activity or object that warrants further investigation, the operator 155 can use the input device 160 to draw a boundary (or box) on the overview video feed (from the overview camera 120) or the inspection video feed (from the PTZ camera 125). This interaction between the operator 155 and the input device 160 is depicted in FIG. 1 by the first two-way arrow 165, and the interaction between the operator 155 and the display device 145 (or graphical user interface) is depicted in FIG. 1 by the second two-way arrow 170.

The boundary drawn by the operator 155 outlines a region of interest within the surveillance area 130. The coordinates of a center of the boundary as well as the pan, tilt, and zoom information for the boundary are gathered by the system 100. This center and PTZ information 175 are input to the system 100 and displayed in the graphical user interface for the operator 155 to observe. In some embodiments the boundary is a box, and the coordinates in x,y of the box as well as the center location of the box are sent to the system 100. Thus, the operator 155 user draws a box on the inspection video feed that contains the video from the overview camera 120 and this box is used to determine the PTZ information for the PTZ camera 125.

embodiments of the system 100 process the center and PTZ information 175 and output the center and zoom information for the PTZ camera 125. The PTZ camera 125 then is moved to the specified location by the box. This is given as pan location, tilt location, and zoom location for the PTZ camera 125.

### II. Operational Overview

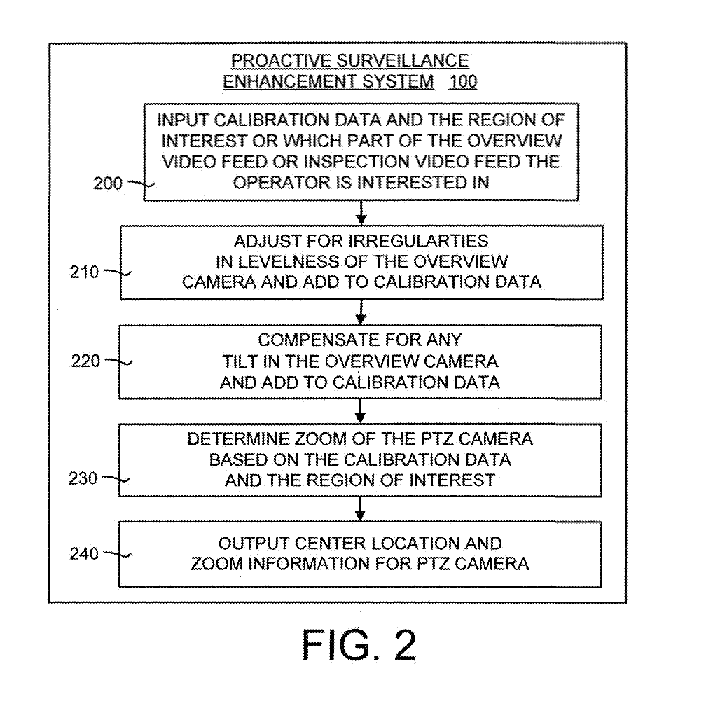

FIG. 2 is a flow diagram illustrating the general operation of embodiments of the proactive surveillance enhancement system 100 shown in FIG. 1. Referring to FIG. 2, the method begins by receiving as input the calibration parameters and the input for which part of the overview video feed or inspection video feed that the operator 155 wants to zoom in on (box 200). The operator information is given by obtaining coordinates of the box that is drawn by the operator 155 in the overview video feed or the inspection video feed displayed on the display device 145. The overview video feed contains the video captured by the overview camera 120 of the surveillance area 130, and the inspection video feed contains the video captured by the PTZ camera 125 of at least a portion of the surveillance area 130.

Next, the system 100 adjusts for any level irregularities in the overview camera 120. Specifically, if the overview camera 120 is not level in the horizontal plane (such as if the overview camera 120 is on a tripod on slanted ground), then a transformation is performed to ensure that the overview camera 120 and the PTZ camera 125 are observing from the same point of view (box 210). Similarly, the system 100 compensates for a tilt angle in of the overview camera 120 (box 220). Any tilt of the overview camera 120 is taken into account and transformation parameters computed to ensure that it appears that the images from the overview camera 120 and the PTZ camera 125 are taken from the same or similar points of view.

Embodiments of the system 100 then determine the zoom of the PTZ camera 125 based on the calibration points given the calibration module 140 (box 230). In particular, the operator 155 draws a box on the overview video feed or the inspection video feed. The system 100 then determines a zoom percentage by dividing the area of the user box by the area of the entire overview video feed or the inspection video feed. This zoom percentage is used to determine how much the PTZ camera 125 zooms in on the region of interest defined by the box.

In some embodiments, the system 100 allows the operator 155 to draw any size rectangular box on the overview video feed or the inspection video feed. The largest dimension (either the height or width) of the box determines the amount of zoom. In other words, if the operator 155 makes a box that is tall and skinny, then the height of the box will dictate the zoom and the width of the box will be proportionally to the height of the box in compliance with the aspect ratio of the overview video feed or the inspection video feed displayed on the display device 145. In other embodiments, the aspect ratio of the box is forced by the system 100, such that the box drawn by the operator 155 on the overview video feed or the inspection video feed will always have the correct aspect ratio.

The output of the system 100 is center location and zoom information that is sent to the PTZ camera 125 (box 240). The center location gives the coordinates of the center of the box drawn by the operator 155 and the zoom information is the pan location, tilt location, and zoom for the PTZ camera 125. The PTZ camera 125 immediately zooms in to the dimensions given by the box that define a region of interest. This means that the inspection video feed now contains video of the region of interest defined by the box that is centered at the location indicated by the operator 155 with the amount of zoom requested by the operator 155 by way of the box drawn in either the overview video feed or the inspection video feed.

### III. Operational Details of Various Embodiments

In embodiments of the proactive surveillance enhancement system 100 and method the operator 155 plays an active role in the ongoing control of the PTZ camera 125 as well as defining and updating regions of interest. The operator 155 also controls the specificity of where the view is enhanced. For example, if a law enforcement officer is interested in a door or window and that is where criminal activity is currently occurring, then in real time the officer can identify those regions of interest even if the new region of interest is different from the original region of interest.

Also, the system 100 allows the operator 155 to determine (prior to drawing a region of interest) whether the activity is critical or important to know. For example, with current video surveillance systems, if a door is made a region of interest during the initialization stage, the current systems will react and zoom in on the area of interest even if there is no criminal activity. In other words, current systems will not differentiate between a suspect and a girl scout coming out of the door. In either case, current systems will zoom in on the region of interest defined during the initialization stage.

On the other hand, embodiments of the proactive surveillance enhancement system 100 and method allow the operator 155 to identify objects or regions of interest in real time even after the initialization stage. The system 100 and method can obtain more relevant information to an ongoing investigation and exclude extraneous information. This is because the operator 155 is part of the real-time region of interest selection process. This is opposed to current video surveillance systems that have the operator identify regions of interest during an initialization stage and then are left to run on their own.

The operational details of embodiments of the proactive surveillance enhancement system 100 and method now will be discussed.

### III.A. First Embodiment

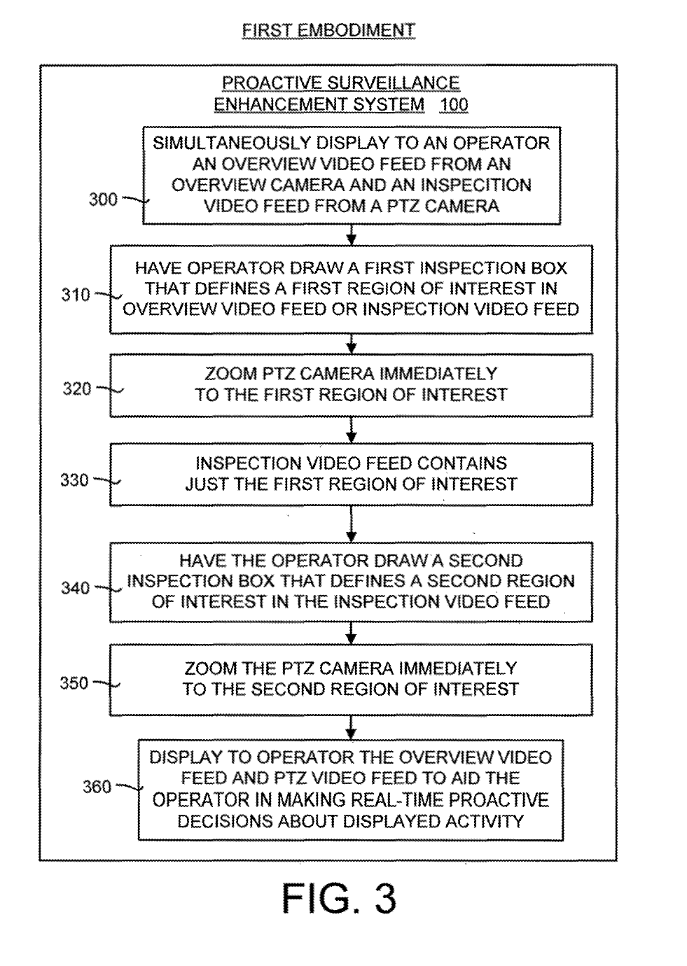

FIG. 3 is a flow diagram illustrating the operational details of a first embodiment of the proactive surveillance enhancement system 100 shown in FIGS. 1 and 2. The method of this first embodiment begins by simultaneously displaying on the display device 145 to an operator 155 an overview video feed from an overview camera and an inspection video feed from the PTZ camera 125 (box 300). The overview camera 120 has an overview of the surveillance area 130 in a field-of-view of the overview camera 120 and the PTZ camera 125 has at least part of the surveillance area 130 in a field-of-view of the PTZ camera 125. Next, the operator 155 draws a first inspection box that defines a first region of interest (box 310). This first region of interest is draw by the operator 155 in either the overview video feed or the inspection video feed. It is important to note that the first region of interest is based on a first observation of activity in the surveillance area 130 needing further inspection as determined by the operator 155.

The size of the first inspection box determines the amount of zoom. This amount of zoom (or the zoom percentage) is determined by dividing the area of the box by the entire area of the overview video feed or the inspection video feed, depending in which one the box is drawn. There are two embodiments of the box. In the first embodiment, the largest dimension of the box (either the height or the width) determines the zoom percentage. The general process for this is as follows: (a) the largest dimension of the box is determined; and, (b) the box is redrawn based on the largest dimension in conformance with an aspect ratio of the overview video feed or the inspection video feed (whichever is being used). In the second embodiment, the aspect ratio is forced such that the height and width of the box always has the correct aspect ratio. Moreover, the center of the box becomes the point at which the PTZ camera 125 is aimed in the surveillance area 130.

Once the box is drawn the PTZ camera 125 is immediately zoomed in on the first region of interest by using the computing device 110 having a processor (box 320). After this zoom the inspection video feed contains just the first region of interest while the overview video feed still contains the overview of the surveillance area 130 (box 330). The operator 155 then draws a second inspection box that defines a second region of interest (box 340). This second region of interest is drawn by the operator 155 in the inspection video feed. The second region of interest is contained within the first region of interest. The operator 155 draws the second inspection box around the second region of interest in the inspection video feed based on a second observation of activity in the first region of interest needing further inspection as determined by the operator 155. In other words, if the operator 155 sees something in the inspection video feed that needs a closer look, the operator 155 draws one or more additional inspection boxes to further zoom in on the object or activity.

The PTZ camera 125 is immediately zoomed on the second region of interest (box 350). At this time the PTZ video feed contains just the second region of interest while the overview video feed still contains the overview of the surveillance area 130. The system 100 displays to the operator 155 the overview video feed and the inspection video feed to aid the operator 155 in making real-time proactive decisions about the second observation of activity in the surveillance area 130 displayed to the operator 155 (box 360).

### III.B. Second Embodiment

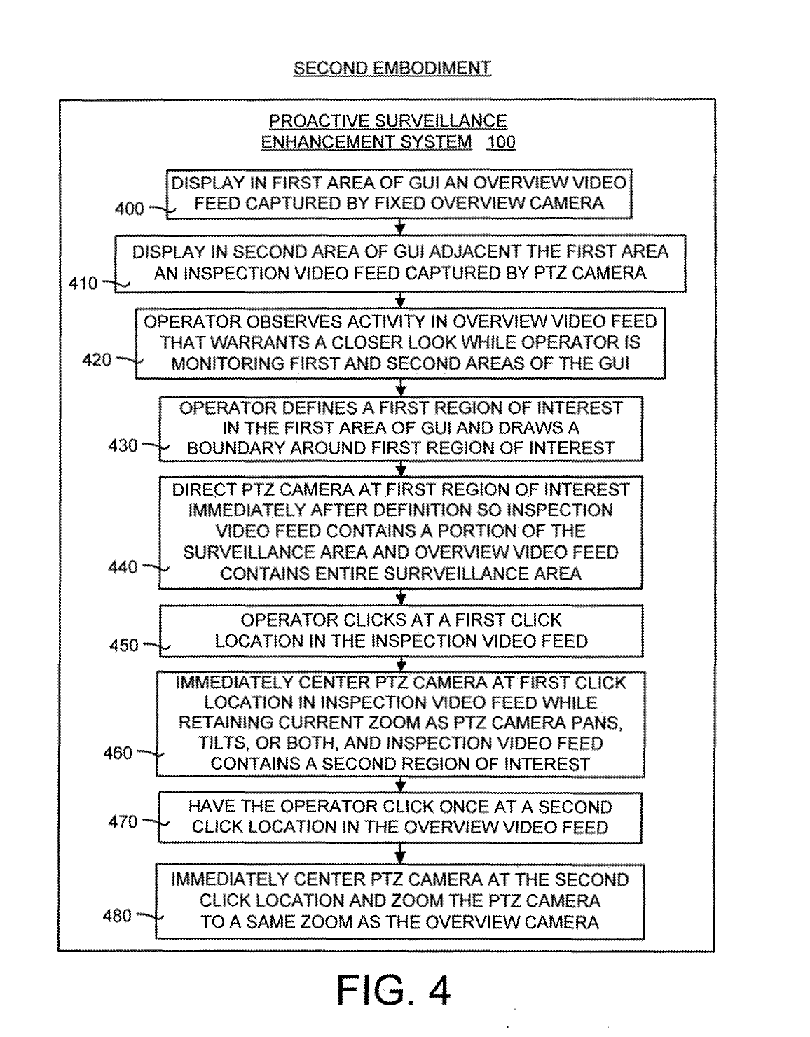

FIG. 4 is a flow diagram illustrating the operational details of a second embodiment of the proactive surveillance enhancement system 100 shown in FIGS. 1 and 2. The method of this second embodiment begins by displaying in a first area of a graphical user interface an overview video feed that was captured by the overview camera 120 (box 400). In this embodiment the overview camera 120 is fixed, meaning that after calibration the pan, tilt, and zoom of the overview camera 120 are not changed. The overview video feed contains an overview of the surveillance area 130 as captured by the overview camera 120.

In addition, the method displays in a second area of the graphical user interface an inspection video feed captured by the PTZ camera 125 (box 410). This second area is adjacent the first area, meaning that the overview video feed and the inspection video feed are displayed simultaneously next to each other in the graphical user interface. The inspection video feed contains the surveillance area 130 as captured by the PTZ camera 125.

Next, the operator 155 observes activity in the overview video feed that the operator decides warrants a closer look (box 420). This occurs while the operator 155 is monitoring the first area and the second area of the graphical user interface. Based on the observed information, the operator 155 defines a first region of interest in the first area of the graphical user interface and draws a boundary around the first region of interest (box 430). The boundary is drawn by the operator 155 in the overview video feed.

Immediately after the operator 155 defines the first region of interest, the PTZ camera 125 is directed at the first region of interest (box 440). After this the inspection video feed displayed in the second area of the graphical user interface contains a portion of the surveillance area 130. Moreover, the overview video feed displayed in the first area of the graphical user interface continues to contain the entire surveillance area 130.

The operator 155 then later clicks at a first click location in the inspection video feed (box 450). The PTZ camera 125 then is immediately centered at the first click location in the inspection video feed (box 460). The current zoom of the PTZ camera 125 is maintained, even while the PTZ camera 125 may be panned, tilted, or both to move to the first click location. This new location at the current zoom is defined as a second region of interest (that is a portion of the surveillance area 130) and is contained in the inspection video feed.

This feature of the proactive surveillance enhancement system 100 and method gives the operator 155 the ability to click once on the inspection video feed and have the PTZ camera 125 center at the first click location while retaining the current zoom. In other words, the inspection video feed centers at the first clicked location such that the zoom remains constant but the center location changes in the inspection video feed. This allows the operator 155 to keep the same zoom and yet follow a moving object of interest in the inspection video feed by merely clicking at a location in the inspection video feed without the need to redraw the boundary.

The operator 155 then determines that he has obtained the desired information from the inspection video feed close-ups. In this case, the system 100 and method give the operator 155 the ability to click once at a second click location in the overview video feed (box 470) and have the PTZ camera 125 immediately center at the second click location and have the zoom of the PTZ camera 125 return to the same zoom as the overview camera 120 (box 480).

### III.C. Third Embodiment

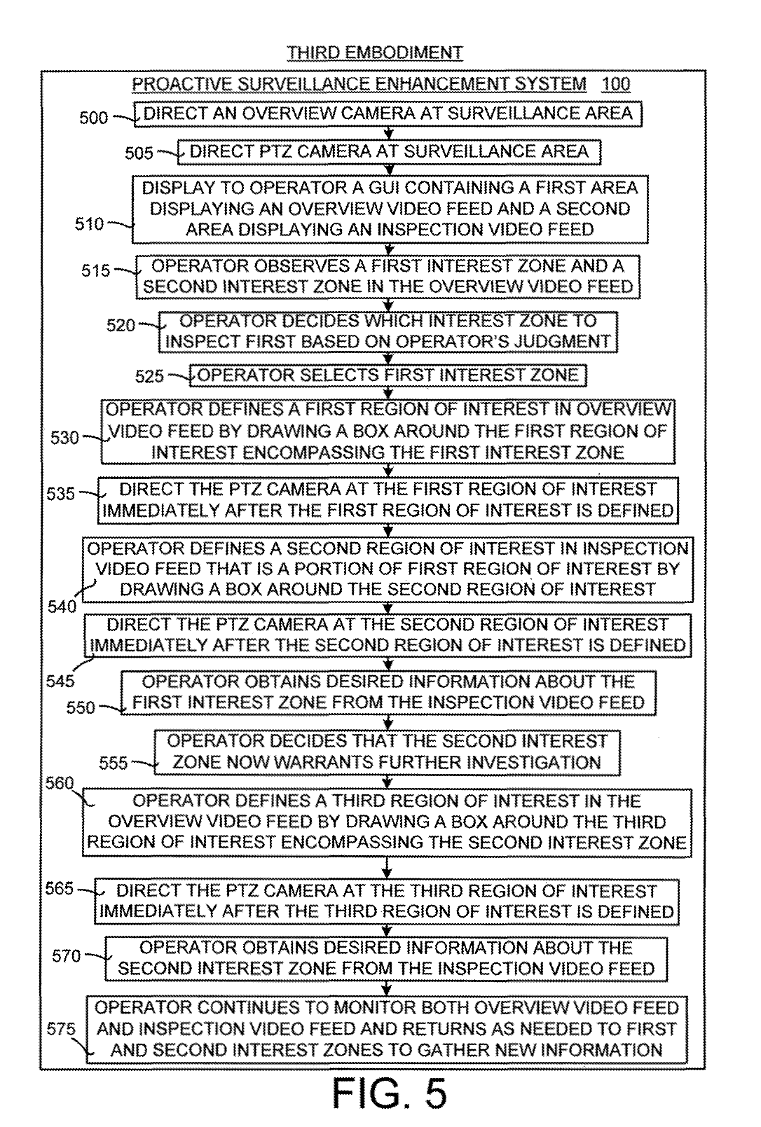

FIG. 5 is a flow diagram illustrating the operational details of a third embodiment of the proactive surveillance enhancement system 100 shown in FIGS. 1 and 2. The method of this third embodiment begins by directing the overview camera 120 having a fixed pan, tilt, and zoom, at the surveillance area 130 (box 500). This enables the overview camera 120 to capture the entire surveillance area 130. In addition, the PTZ camera 125 is directed at the surveillance area 130 (box 505). This allows the PTZ camera 125 to capture at least a portion of the surveillance area 130.

The method then displays to the operator 155 a graphical user interface that contains a first area and a second area (box 510). The first area displays a live feed of the overview video feed as captured byte overview camera 120. The second area displays a live feed of the inspection video feed as captured by the PTZ camera 125. The first and the second areas both are contained in the graphical user interface and displayed simultaneously to the operator 155.

The operator 155 then observes a first interest zone of the surveillance area 130 (as seen through the overview video feed) and a second interest zone of the surveillance area 130 (as seen through the overview video feed) (box 515). These two interest zones may include, for example, activities, persons, or objects that the operator 155 believes may be important to the purposes of the video surveillance. The operator 155 then prioritizes the interest zones by deciding in which order to inspect the interest zones. In this case, the operator 155 decides whether to inspect the first interest zone or the second interest zone (box 520). This decision typically is based on the judgment of the operator 155. For example, if the operator 155 is a law-enforcement officer, he may rely on his knowledge of law enforcement and surveillance to makes this decision.

The operator 155 then decides that the first interest zone warrants further investigation and then selects the first interest zone (box 525). Based on this decision, the operator 155 defines a first region of interest in the overview video feed by drawing a box around the first region of interest (box 530). This box encompasses the first interest zone as depicted in the overview video feed. The PTZ camera 125 then is directed at the first region of interest immediately after the first region of interest is defined (box 535).

The operator 155 then defines a second region of interest in the inspection video feed by drawing a box around the second region of interest (box 540). In this case, the second region of interest is a portion of the first region of interest. This means that the operator 155 desires a closer look at a specific feature, object, or activity in the first region of interest. The PTZ camera 125 is directed at the second region of interest immediately after the second region of interest is defined (box 545). The operator 155 then obtains the desired information about the first interest zone from the inspection video feed that is zoomed in on a certain portion of the first interest zone based on the second region of interest (box 550).

Once the operator 155 has the desired information about, the first interest zone, the operator 155 then decides that the second interest zone now warrants further investigation (box 555). In order to facilitate further investigation, the operator 155 defines a third region of interest in the overview video feed that encompasses the second interest zone (box 560). The third region of interest is identified by the operator 155 drawing a box around the third region of interest. Immediately after the third region of interest is defined the PTZ camera 125 is directed at the third region of interest (box 565). The operator 155 then obtains the desired information about the second interest zone from the inspection video feed that is zoomed in on a certain portion of the second interest zone based on the third region of interest (box 570). The operator 155 continues to monitor both the overview video feed and the inspection video feed (box 575). The operator 155 can return as needed to the first interest zone and the second interest zone to gather additional information in these areas. This is done by drawing a box around interest zones to create additional regions of interest. The PTZ camera then can zoom in on each region of interest as instructed by the operator 155.

### IV. Exemplary Operating Environment

Embodiments of the proactive surveillance enhancement system 100 and method are designed to operate in a computing environment. The following discussion is intended to provide a brief, general description of a suitable computing environment in which embodiments of the proactive surveillance enhancement system 100 and method may be implemented.

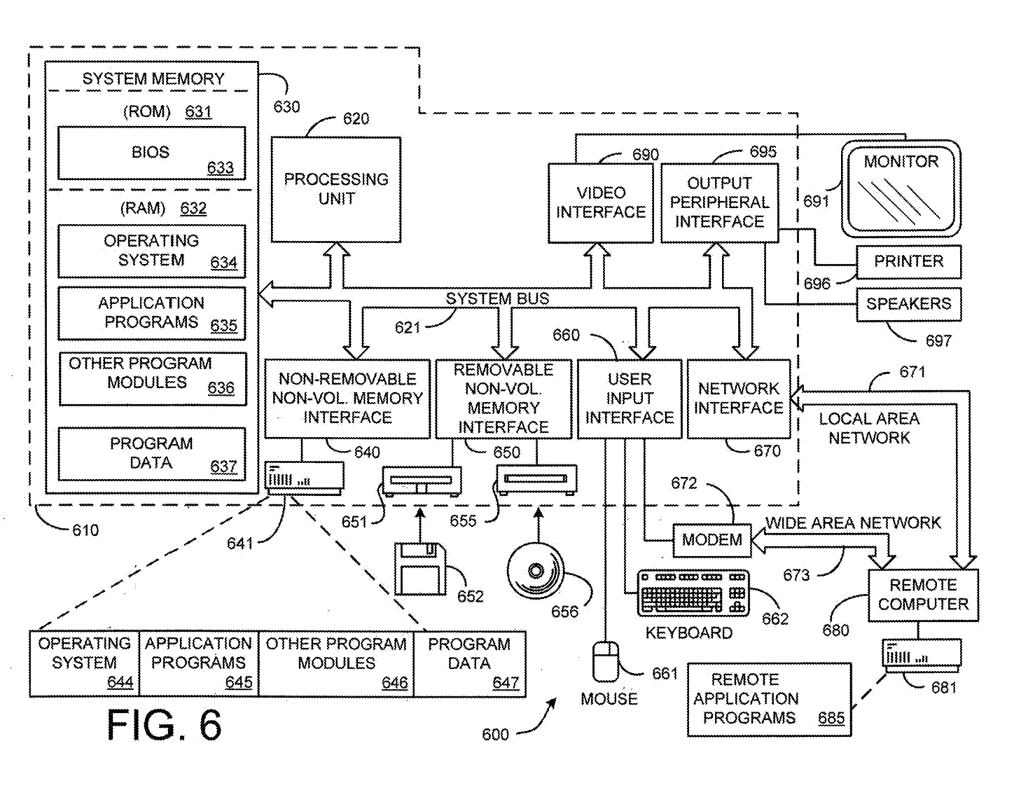

FIG. 6 illustrates an example of a suitable computing system environment in which embodiments of the proactive surveillance enhancement system 100 and method shown in FIGS. 1-5 may be implemented. The computing system environment 600 is only one example of a suitable computing environment and is not intended to suggest any limitation as to the scope of use or functionality of the invention. Neither should the computing environment 600 be interpreted as having any dependency or requirement relating to any one or combination of components illustrated in the exemplary operating environment.

Embodiments of the proactive surveillance enhancement system 100 and method are operational with numerous other general purpose or special purpose computing system environments or configurations. Examples of well known computing systems, environments, and/or configurations that may be suitable for use with embodiments of the proactive surveillance enhancement system 100 and method include, but are not limited to, personal computers, server computers, hand-held (including smartphones), laptop or mobile computer or communications devices such as cell phones and PDA's, multiprocessor systems, microprocessor-based systems, set top boxes, programmable consumer electronics, network PCs, minicomputers, mainframe computers, distributed computing environments that include any of the above systems or devices, and the like.

Embodiments of the proactive surveillance enhancement system 100 and method may be described in the general context of computer-executable instructions, such as program modules, being executed by a computer. Generally, program modules include routines, programs, objects, components, data structures, etc., that perform particular tasks or implement particular abstract data types. Embodiments of the proactive surveillance enhancement system 100 and method may also be practiced in distributed computing environments where tasks are performed by remote processing devices that are linked through a communications network. In a distributed computing environment, program modules may be located in both local and remote computer storage media including memory storage devices. With reference to FIG. 6, an exemplary system for embodiments of the proactive surveillance enhancement system 100 and method includes a general-purpose computing device in the form of a computer 610.

Components of the computer 610 may include, but are not limited to, a processing unit 620 (such as a central processing unit, CPU), a system memory 630, and a system bus 621 that couples various system components including the system memory to the processing unit 620. The system bus 621 may be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus also known as Mezzanine bus.

The computer 610 typically includes a variety of computer readable media. Computer readable media can be any available media that can be accessed by the computer 610 and includes both volatile and nonvolatile media, removable and non-removable media. By way of example, and not limitation, computer readable media may comprise computer storage media and communication media. Computer storage media includes volatile and nonvolatile removable and non-removable media implemented in any method or technology for storage of information such as computer readable instructions, data structures, program modules or other data.

Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can be accessed by the computer 610. By way of example, and not limitation, communication media includes wired media such as a wired network or direct-wired connection, and wireless media such as acoustic, RF, infrared and other wireless media. Combinations of any of the above should also be included within the scope of computer readable media.

The system memory 630 includes computer storage media in the form of volatile and/or nonvolatile memory such as read only memory (ROM) 631 and random access memory (RAM) 632. A basic input/output system 633 (BIOS), containing the basic routines that help to transfer information between elements within the computer 610, such as during start-up, is typically stored in ROM 631. RAM 632 typically contains data and/or program modules that are immediately accessible to and/or presently being operated on by processing unit 620. By way of example, and not limitation, FIG. 6 illustrates operating system 634, application programs 635, other program modules 636, and program data 637.

The computer 610 may also include other removable/non-removable, volatile/nonvolatile computer storage media. By way of example only, FIG. 6 illustrates a hard disk drive 641 that reads from or writes to non-removable, nonvolatile magnetic media, a magnetic disk drive 651 that reads from or writes to a removable, nonvolatile magnetic disk 652, and an optical disk drive 655 that reads from or writes to a removable, nonvolatile optical disk 656 such as a CD ROM or other optical media.

Other removable/non-removable, volatile/nonvolatile computer storage media that can be used in the exemplary operating environment include, but are not limited to, magnetic tape cassettes, flash memory cards, digital versatile disks, digital video tape, solid state RAM, solid state ROM, and the like. The hard disk drive 641 is typically connected to the system bus 621 through a non-removable memory interface such as interface 640, and magnetic disk drive 651 and optical disk drive 655 are typically connected to the system bus 621 by a removable memory interface, such as interface 650.

The drives and their associated computer storage media discussed above and illustrated in FIG. 6, provide storage of computer readable instructions, data structures, program modules and other data for the computer 610. In FIG. 6, for example, hard disk drive 641 is illustrated as storing operating system 644, application programs 645, other program modules 646, and program data 647. Note that these components can either be the same as or different from operating system 634, application programs 635, other program modules 636, and program data 637. Operating system 644, application programs 645, other program modules 646, and program data 647 are given different numbers here to illustrate that, at a minimum, they are different copies. A user may enter commands and information (or data) into the computer 610 through input devices such as a keyboard 662, pointing device 661, commonly referred to as a mouse, trackball or touch pad, and a touch panel or touch screen (not shown).

Other input devices (not shown) may include a microphone, joystick, game pad, satellite dish, scanner, radio receiver, or a television or broadcast video receiver, or the like. These and other input devices are often connected to the processing unit 620 through a user input interface 660 that is coupled to the system bus 621, but may be connected by other interface and bus structures, such as, for example, a parallel port, game port or a universal serial bus (USB). A monitor 691 or other type of display device 145 is also connected to the system bus 621 via an interface, such as a video interface 690. In addition to the monitor, computers may also include other peripheral output devices such as speakers 697 and printer 696, which may be connected through an output peripheral interface 695.

The computer 610 may operate in a networked environment using logical connections to one or more remote computers, such as a remote computer 680. The remote computer 680 may be a personal computer, a server, a router, a network PC, a peer device or other common network node, and typically includes many or all of the elements described above relative to the computer 610, although only a memory storage device 681 has been illustrated in FIG. 6. The logical connections depicted in FIG. 6 include a local area network (LAN) 671 and a wide area network (WAN) 673, but may also include other networks. Such networking environments are commonplace in offices, enterprise-wide computer networks, intranets and the Internet.

When used in a LAN networking environment, the computer 610 is connected to the LAN 671 through a network interface or adapter 670. When used in a WAN networking environment, the computer 610 typically includes a modem 672 or other means for establishing communications over the WAN 673, such as the Internet. The modem 672, which may be internal or external, may be connected to the system bus 621 via the user input interface 660, or other appropriate mechanism. In a networked environment, program modules depicted relative to the computer 610, or portions thereof, may be stored in the remote memory storage device. By way of example, and not limitation, FIG. 6 illustrates remote application programs 685 as residing on memory device 681. It will be appreciated that the network connections shown are exemplary and other means of establishing a communications link between the computers may be used.

The foregoing Detailed Description has been presented for the purposes of illustration and description. Many modifications and variations are possible in light of the above teaching. It is not intended to be exhaustive or to limit the subject matter described herein to the precise form disclosed. Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims appended hereto.

What is claimed is:

1. A method for conducting proactive video surveillance, comprising:
simultaneously displaying on a display device to an operator an overview video feed from an overview camera having an overview of a surveillance area in a field-of-view of the overview camera and an inspection video feed from a pan-tilt-zoom (PTZ) camera having at least part of the surveillance area in a field-of-view of the PTZ camera;
defining a first region of interest by having the operator draw a first inspection box around the first region of interest in either the overview video feed or the inspection video feed based on a first observation of activity in the surveillance area needing further inspection as determined by the operator;
zooming the PTZ camera immediately on the first region of interest using a computing device having a processor such that the PTZ video feed contains just the first region of interest while the overview video feed still contains the overview of the surveillance area;
defining a second region of interest contained within the first region of interest by having the operator draw a second inspection box around the second region of interest in the inspection video feed based on a second observation of activity in the first region of interest needing further inspection as determined by the operator;
zooming the PTZ camera immediately on the second region of interest using the computing device having a processor such that the PTZ video feed contains just the second region of interest while the overview video feed still contains the overview of the surveillance area; and
displaying to the operator the overview video feed and the PTZ video feed to aid the operator in making real-time proactive decisions about the second observation of activity in the surveillance area displayed to the operator.

2. The method of claim 1, further comprising zooming in the PTZ camera on the first region of interest irrespective of any motion with the first region of interest.

3. The method of claim 2, further comprising determining an amount of zoom for the PTZ camera based on a size of the first inspection box.

4. The method of claim 3, further comprising determining the amount of zoom by dividing an area of the first inspection box by an area of the overview video feed displayed on the display device.

5. The method of claim 4, further comprising:
determining a largest dimension of the first inspection box as either a height or a width of the first inspection box; and
redrawing the first inspection box based on the largest dimension such that the first inspection box conforms to an aspect ratio of the PTZ video feed displayed on the display device.

6. The method of claim 4, further comprising forcing a size of the first inspection box to conform to an aspect ratio of the display device such that a height and a width of the first inspection box are always at the aspect ratio.

7. The method of claim 3, further comprising:
computing a center of the first inspection box;
determining pan, tilt, and zoom information based on a location of the first inspection; and
zooming the PTZ camera immediately on the first region of interest using the pan, tilt, and zoom information and by centering the PTZ camera on the center of the first inspection box.

8. The method of claim 1, further comprising defining only one region of interest at a time such that there are never two regions of interest defined simultaneously.

9. The method of claim 1, further comprising simultaneously displaying the overview video feed and the inspection video feed to the operator in a single graphical user interface using the display device.

10. The method of claim 1, further comprising:
having the operator use an input device to click once at a desired location in the overview video feed; and
causing the PTZ camera to return to a same zoom as the overview camera and be centered at the desired location.

11. The method of claim 1, further comprising:
having the operator use an input device to click once at a desired location in the inspection video feed; and
causing the PTZ camera to center at the desired location and retain a current zoom of the PTZ camera.

12. The method of claim 1, wherein defining the first region of interest further comprises having the operator draw the first inspection box based on the operator's first observation of activity without any need for pre-defined dwell times, a viewing order for multiple regions of interest, or other region of interest conflict rules.

13. A method implemented on a computing device having a processor for performing video surveillance of a surveillance area using a graphical user interface displayed on a display device in communication with the computing device, comprising:
displaying in a first area of the graphical user interface an overview video feed that contains an overview of the surveillance area as captured by an overview camera that is fixed in location and zoom after calibration;
displaying in a second area of the graphical user interface that is adjacent the first area an inspection video feed that contains the surveillance area as captured by a pan-tilt-zoom (PTZ) camera;
observing activity in the overview video feed that the operator determines warrants a closer look as the operator is monitoring the first and second areas of the graphical user interface;
defining a first region of interest in the first area of the graphical user interface by having the operator draw a first boundary around the first region of interest in the overview video feed;
directing the PTZ camera at the first region of interest immediately after the first region of interest is defined such that the inspection video feed contains the first region of interest that is a portion of the surveillance area and the overview video feed still contains the entire surveillance area;
having the operator click at a first click location in the inspection video feed; and
immediately centering the PTZ camera at the click location in the inspection video feed while retaining a current zoom such that the PTZ camera pans, tilts, or does both, and the inspection video feed contains a second region of interest that is a portion of the surveillance area.

14. The method of claim 13, further comprising:
observing activity in the inspection video feed that the operator determines warrants a closer look as the operator is monitoring the first and second areas of the graphical user interface; and
defining a third region of interest in the second area of the graphical user interface by the having the operator draw a second boundary around the third region of interest in the inspection video feed.

15. The method of claim 14, further comprising directing the PTZ camera at the third region of interest immediately after the third region of interest is defined such that the inspection video feed contains the third region of interest that is a portion of the second region of interest and the overview video feed still contains the entire surveillance area.

16. The method of claim 15, further comprising:
having the operator click once at a second click location in the overview video feed; and
immediately centering the PTZ camera at the second click location and zooming the PTZ camera to a same zoom as the overview camera.

17. A computer-implemented method for enhancing video surveillance of a surveillance area, comprising:
directing an overview camera having a fixed pan, a fixed tilt, and a fixed zoom, at the surveillance area to capture the entire surveillance area;
directing a pan-tilt-zoom (PTZ) camera at the surveillance area to capture at least a portion of the surveillance area;
displaying to an operator a graphical user interface containing a first area displaying an overview video feed showing live video captured by the overview camera, and a second area displaying an inspection video feed showing live video captured by the PTZ camera, where the first and second areas are contained together in the graphical user interface;
observing a first interest zone in the overview video feed and a second interest zone in the overview video feed;
prioritizing which interest zone to inspect by deciding whether to inspect the first interest zone or the second interest zone based on a judgment of the operator;
deciding that the first interest zone warrants further investigation before the second interest zone;
defining a first region of interest in the overview video feed by having the operator draw a box around the first region of interest that encompasses the first interest zone;
directing the PTZ camera at the first region of interest immediately after the first region of interest is defined;
defining a second region of interest in the inspection video feed by having the operator draw a box around the second region of interest that is a portion of the first region of interest;
directing the PTZ camera at the second region of interest immediately after the second region of interest is defined; and
obtaining desired information about the first interest zone from the inspection video feed.

18. The computer-implemented method of claim 17, further comprising:
deciding that the second interest zone warrants further investigation after having obtained the desired information about the first interest zone;
defining a third region of interest in the overview video feed by having the operator draw a box around the third region of interest that encompasses the second interest zone;
directing the PTZ camera at the third region of interest immediately after the third region of interest is defined; and
obtaining desired information about the second interest zone from the inspection video feed.

19. The computer-implemented method of claim 18, further comprising:
having the operator continuously monitor both the overview video feed and the inspection video feed through the graphical user interface to determine where a subsequent region of interest should be defined in the overview video feed or inspection video feed; and
having the operator determine a length of time between defining the first region of interest, the second region of interest, and the third region of interest based on the judgment of the operator such that there is no predetermined time that the first region of interest and the second region of interest is displayed in the inspection video feed.

20. The computer-implemented method of claim 19, wherein motion in the first region of interest of the surveillance area has no effect on a positioning or a zoom of the PTZ camera.
